(19) United States
(12) Patent Application Publication
(10) Pub. No.: US 2018/0278912 A1
(43) Pub. Date: Sep. 27, 2018

(54) THREE DIMENSIONAL DISPLAY SCREEN

(71) Applicants: Fu Tai Hua Industry (Shenzhen) Co., Ltd., Shenzhen (CN); HON HAI PRECISION INDUSTRY CO., LTD., New Taipei (TW)

(72) Inventors: XIN YANG, Shenzhen (CN); WEN-JIE WANG, Shenzhen (CN)

(73) Assignees: Fu Tai Hua Industry (Shenzhen) Co., Ltd., Shenzhen (CN); HON HAI PRECISION INDUSTRY CO., LTD., New Taipei (TW)

(21) Appl. No.: 15/615,266

(22) Filed: Jun. 6, 2017

(30) Foreign Application Priority Data
Mar. 22, 2017 (CN) 201710172673.9

(51) Int. Cl. H04N 13/04; G02B 27/22; H04N 13/00; G02F 1/1347; G09G 3/00

(52) U.S. Cl. CPC H04N 13/0404; G02B 27/2221; G09G 3/003; G02B 27/2278; G02F 1/1347; H04N 13/0055

(57) ABSTRACT

A display screen which simulates a three dimensional (3D) projection without optical glasses assistance includes a cover glass layer, a thin film transistor (TFT) layer, a back light layer, a substrate layer, a sensing layer, and a driving circuit. The substrate layer is between the cover glass layer and the TFT layer. The sensing layer is above the cover glass layer. A plurality of light emitting diode (LED) assemblies is on the substrate layer and a plurality of convex lens assemblies is on the cover glass layer. The driving circuit controls the LED assemblies to emit light as light gathering points. The sensing layer detects distances between the light gathering points and the sensing layer. The driving circuit further controls each convex lens assembly to zoom and convert each light gathering point according to the relevant distance to simulate a 3D appearance.

### FIELD

The subject matter herein generally relates to a three dimensional (3D) display screen.

### BACKGROUND

3D image technology is applied in fields such as information communication, medical care, education and training, games, animations, virtual reality, etc. A viewer typically views an image displayed through 3D glasses. A 3D screen, which the viewer can directly view the image displayed in 3D rather than through the 3D glasses, would be preferred.

### BRIEF DESCRIPTION OF THE DRAWINGS

Implementations of the present technology will now be described, by way of example only, with reference to the attached figures.

FIG. 1 is a diagram of an exemplary embodiment of a 3D display screen.

FIG. 2 is a diagram of an exemplary embodiment of voltage loads to tri-color LEDs in the 3D display screen of FIG. 1.

FIG. 3 is a diagram of an exemplary embodiment of a plurality of light gathering points generated by a plurality of LED assemblies in the 3D display screen of FIG. 1.

FIG. 4 is a diagram of an exemplary embodiment of a plurality of sensors and a plurality of convex lens assemblies in the 3D display screen of FIG. 1.

FIG. 5 is a diagram of an exemplary embodiment of a convex lens.

FIG. 6 is a diagram illustrating a first convex lens assembly zooming and converting a first light gathering point in the 3D display screen of FIG. 1 according to an exemplary embodiment of the instant disclosure.

FIG. 7 is a diagram illustrating a second convex lens assembly zooming and converting a second light gathering point in the 3D display screen of FIG. 1 according to an exemplary embodiment of the instant disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure. It should be noted that references to “an” or “one” embodiment in this disclosure are not necessarily to the same embodiment, and such references mean “at least one”.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series, and the like.

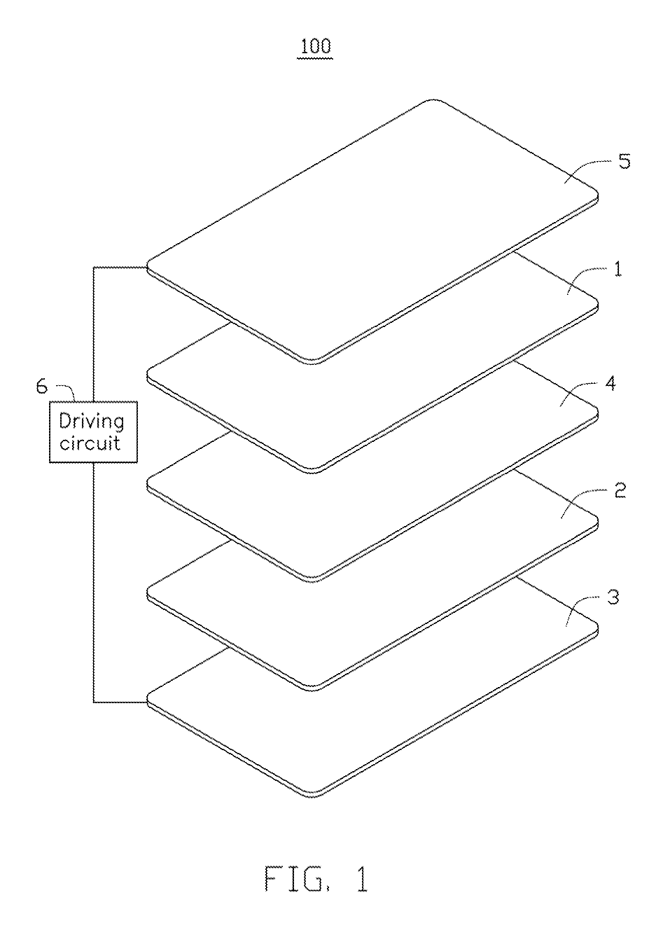

FIG. 1 illustrates a 3D display screen 100 in accordance with an exemplary embodiment.

The 3D display screen 100 comprises a cover glass layer 1, a thin film transistor (TFT) layer 2, a back light layer 3, a substrate layer 4, a sensing layer 5, and a driving circuit 6. The back light layer 3 is configured to provide background light. The substrate layer 4 is located between the cover glass layer 1 and the TFT layer 2. The sensing layer 5 is located above the cover glass layer 1.

Referring to FIG. 3, a plurality of light emitting diode (LED) assemblies are installed on the substrate layer 4. The plurality of LED assemblies in this exemplary embodiment comprises three LED assemblies, 7a to 7c.

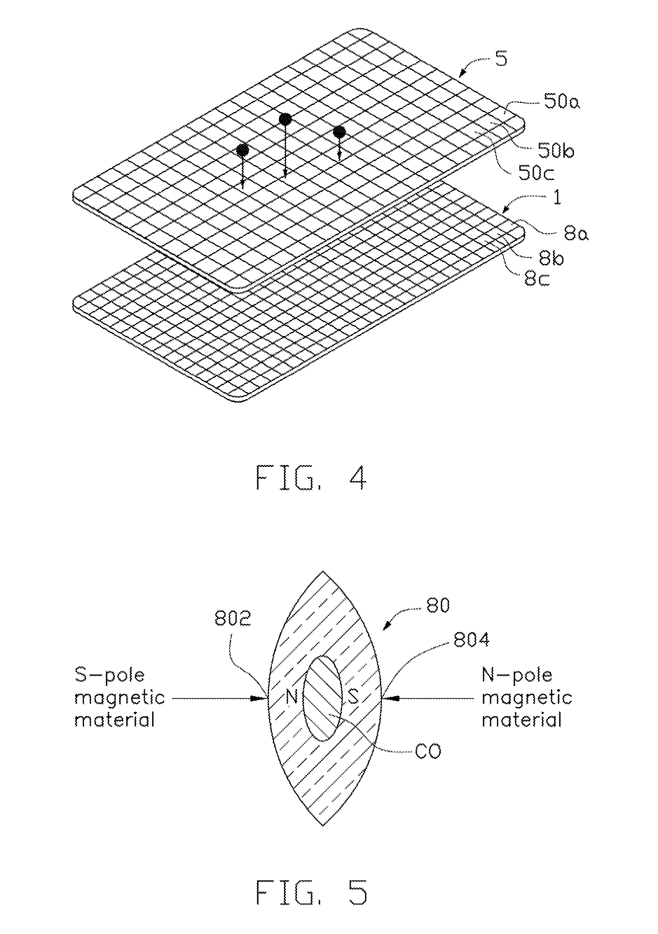

Referring to FIG. 4, a plurality of convex lens assemblies 8a to 8c are installed on the cover glass layer 1, and one convex lens assembly 8a to 8c corresponds to one LED assembly 7a to 7c. In this exemplary embodiment, three convex lens assemblies, 8a to 8c are provided as an example.

Referring to FIGS. 1 and 3, the driving circuit 6 is configured to drive and control the LED assemblies 7a to 7c to emit light to form a plurality of light gathering points. The sensing layer 5 is configured to detect distances between each light gathering point and the sensing layer 5. The driving circuit 6 is further configured to control each of the convex lens assemblies 8a to 8c to zoom and convert each light gathering point according to a relevant distance.

In one exemplary embodiment, the driving circuit 6 controls one of the convex lens assemblies 8a to 8c to zoom and convert one of the gathering points according to the relevant distance. Each light gathering point comprises the relevant distance from the sensing layer 5. For example, a first light gathering point corresponds to a first distance, a second light gathering point corresponds to a second distance, and a third light gathering point corresponds to a third distance.

When the LED assembly 7a generates a first light gathering point, the sensing layer 5 detects a first distance between the first light gathering point and the sensing layer 5, and the driving circuit 6 controls the convex lens assembly 8a to zoom to convert the first light gathering point according to the first distance. When the LED assembly 7b generates a second light gathering point, the sensing layer 5 detects a second distance between the second light gathering point and the sensing layer 5, and the driving circuit 6 controls the convex lens assembly 8b to zoom to convert the second light gathering point according to the second distance. When the LED assembly 7c generates a third light gathering point, the sensing layer 5 detects a third distance between the third light gathering point and the sensing layer 5, and the driving circuit 6 controls the convex lens assembly 8c to zoom to convert the third light gathering point according to the third distance.

In one exemplary embodiment, the cover glass layer 1 can be a glass that has multi-touch function. If the light gathering points have different distances relative to the sensing layer 5, the light gathering points can be located in different layers in space.

In one exemplary embodiment, the substrate layer 4 can be a flexible polyimide layer. The sensing layer 5 can comprise a plurality of sensors. The plurality of sensors in this exemplary embodiment comprises three sensors 50a to 50c. Each of the sensors 50a to 50c detects a distance between one of the light gathering points and the sensing layer 5.

In one exemplary embodiment, the sensing layer 5 can be omitted. The plurality of sensors 50a to 50c can be installed in the cover glass layer 1. Then, each of the sensors 50a to 50c can detect the distance between each of the light gathering points and the cover glass layer 1.

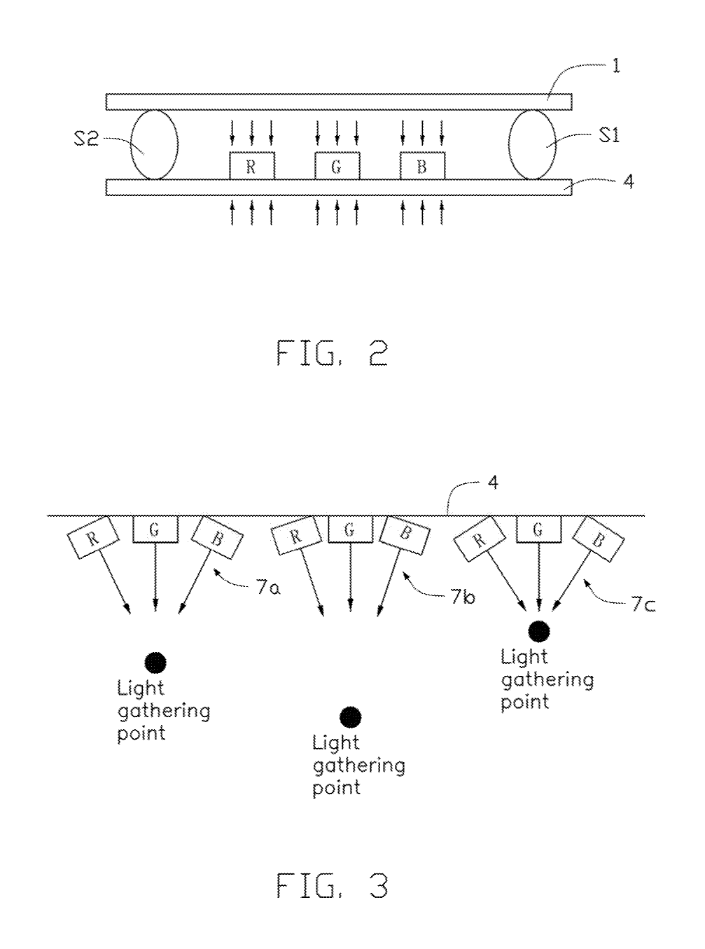

Referring to FIGS. 2-3, each of the LED assemblies 7a to 7c comprises a red LED (LED R), a green LED (LED G), and a blue LED (LED B). The LEDs R, G, and B can be driven by the driving circuit 6.

When the driving circuit 6 applies an uneven voltage between top surfaces of LEDs R, G, and B and lower surfaces of the substrate layer 4, the LEDs R, G, and B deflect to form the light gathering point.

In one exemplary embodiment, the uneven voltage can be a waveform voltage. The LEDs R, G, and B can induce deflection by the flexible substrate layer 4. The LEDs R, G, and B can have different deflection angles.

In one exemplary embodiment, at least two spacers S1 and S2 are set between the substrate layer 4 and the cover glass layer 1. A height of each of the two spacers S1 and S2 is greater than a height of each of the tri-color LEDs R, G, and B.

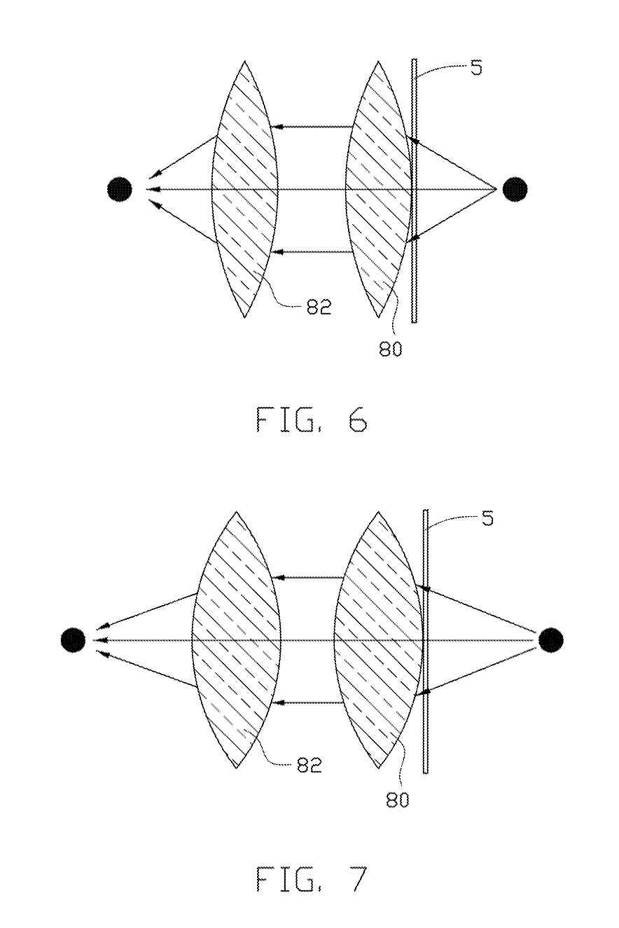

In one exemplary embodiment, each of the convex lens assemblies 8a to 8c comprises a first convex lens 80 and a second convex lens 82 as referred to in FIGS. 4 and 6. The first convex lens 80 and the second convex lens 82 are set in parallel to realize zoom features. The driving circuit 6 controls side walls of the first convex lens 80 and the second convex lens 82 to expand or contract according to the relevant distance to zoom. An expanding value and a contracting value are determined by the distances between each of the light gathering points and the sensing layer 5.

In one exemplary embodiment, the first convex lens 80 and the second convex lens 82 synchronously expand or contract.

Referring to FIG. 5, a coil CO is installed inside each convex lens 80 and 82. Each of the convex lenses 80 and 82 comprises a first side wall 802 and a second side wall 804. The first side wall 802 of each convex lenses 80 and 82 comprises S-pole magnetic materials, and the second side wall 804 of each convex lenses 80 and 82 comprises N-pole magnetic materials.

For example, when the coil CO of the first convex lens 80 is powered on, the coil CO generates a magnetic field. An N pole of the coil CO can attract the first side wall (S-pole magnetic materials) of the first convex lens 80, and an S pole of the coil CO can attract the second side wall (N-pole magnetic materials) of the first convex lens 80. Thereby, the first convex lens 80 is contracted. When the coil CO has different current values, the coil CO generates different intensities of magnetic fields.

The driving circuit 6 is further configured to regulate a current of the coil CO according to the distance between one of the light gathering points and the sensing layer 5. When a distance between a light gathering point and the sensing layer 5 increases, degrees of convexity of the first convex lens 80 and the second convex lens 82 increases.

Referring to FIGS. 6-7, the first distance between the first light gathering point and the sensing layer 5 of FIG. 6 is less than the second distance between the second light gathering point and the sensing layer 5 of FIG. 7. The convex lenses of FIG. 7 have larger degrees of convexity than the convex lenses of FIG. 6.

The exemplary embodiments shown and described above are only examples. Many such details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size, and arrangement of the parts within the principles of the present disclosure, up to and including the full extent established by the broad general meaning of the terms used in the claims. It will therefore be appreciated that the exemplary embodiments described above may be modified within the scope of the claims.

What is claimed is:

1. A three dimensional (3D) display screen comprising:
a cover glass layer;
a thin film transistor (TFT) layer;
a back light layer;
a substrate layer between the cover glass layer and the TFT layer;
a sensing layer above the cover glass layer; and
a driving circuit;
wherein a plurality of light emitting diode (LED) assemblies are on the substrate layer; a plurality of convex lens assemblies is on the cover glass layer, one convex lens assembly corresponds to one LED assembly; the driving circuit drives and controls the plurality of LED assemblies to emit light and to form a plurality of light gathering points; the sensing layer detects distances between each light gathering point and the sensing layer; and the driving circuit controls each convex lens assembly to zoom and convert each light gathering point according to a relevant distance.

2. The 3D display screen of claim 1, wherein the substrate layer is a flexible polyimide layer.

3. The 3D display screen of claim 2, wherein each LED assembly comprises a red LED, a green LED, and a blue LED; and
when the driving circuit applies an uneven voltage between top surfaces of the red LED, the green LED, the blue LED and a lower surface of the substrate layer; wherein the red LED, the green LED, and the blue LED induce deflection to form the light gathering point.

4. The 3D display screen of claim 1, wherein each convex lens assembly comprises a first convex lens and a second convex lens in parallel.

5. The 3D display screen of claim 4, wherein the driving circuit controls side walls of the first convex lens and the second convex lens to expand or contract according to the relevant distance to zoom.

6. The 3D display screen of claim 5, wherein when a distance between a light gathering point and the sensing layer increases, and degrees of convexity of the first convex lens and the second convex lens increases.

7. The 3D display screen of claim 5, wherein a coil is installed inside each convex lens; and each convex lens comprises a first side wall and a second side wall, the first side wall of each convex lens comprises S-pole magnetic materials, and the second side wall of each convex lens comprises N-pole magnetic materials.

8. The 3D display screen of claim 7, wherein the driving circuit further regulates a current of each coil according to the distance between each light gathering point and the sensing layer.

9. The 3D display screen of claim 1, wherein the sensing layer comprises a plurality of sensors, each sensor detects the distance between each light gathering point and the sensing layer.

10. The 3D display screen of claim 1, wherein at least two spacers are set between the substrate layer and the cover glass layer.

11. A 3D display screen comprising:
a cover glass layer;
a TFT layer;
a back light layer;
a substrate layer between the cover glass layer and the TFT layer; and
a driving circuit;
wherein a plurality of LED assemblies are on the substrate layer; a plurality of convex lens assemblies and a plurality of sensors are on the cover glass layer, one convex lens assembly corresponds to one LED assembly and one sensor; the driving circuit drives and controls the plurality of LED assemblies to emit light to form a plurality of light gathering points; each sensor detects a distance between each light gathering point and the sensing layer; and the driving circuit further controls each convex lens assembly to zoom and convert each light gathering point according to a relevant distance.

12. The 3D display screen of claim 11, wherein the substrate layer is a flexible polyimide layer.

13. The 3D display screen of claim 12, wherein each LED assembly comprises a red LED, a green LED, and a blue LED; and
when the driving circuit applies an uneven voltage between the top surfaces of the red LED, the green LED, the blue LED and a lower surface of the substrate layer, the red LED, the green LED, and the blue LED induce deflection to form the light gathering point.

14. The 3D display screen of claim 11, wherein each convex lens assembly comprises a first convex lens and a second convex lens in parallel.

15. The 3D display screen of claim 14, wherein the driving circuit controls side walls of the first convex lens and the second convex lens to expand or contract according to the relevant distance to zoom.

16. The 3D display screen of claim 15, wherein when a distance between a light gathering point and the sensing layer increases, and degrees of convexity of the first convex lens and the second convex lens increases.

17. The 3D display screen of claim 15, wherein a coil is installed inside of each convex lens; and each convex lens comprises a first side wall and a second side wall, the first side wall of each convex lens comprises S-pole magnetic materials, and the second side wall of each convex lens comprises N-pole magnetic materials.

18. The 3D display screen of claim 17, wherein the driving circuit further regulates a current of each coil according to the distance between each light gathering point and the sensing layer.

19. The 3D display screen of claim 11, wherein at least two spacers are set between the substrate layer and the cover glass layer.
